(19) United States
(12) Patent Application Publication
(10) Pub. No.: US 2006/0041337 A1
(43) Pub. Date: Feb. 23, 2006

(54) Web-enabled engine reprogramming

(76) Inventors: Brett Neal Augsburger, Auburn, AL (US); Nagaraj Ejantkar, Auburn, AL (US); Michael Heckenbach, Lindenhurst, IL (US)

Correspondence Address: OLSON & HIERL, LTD., 20 NORTH WACKER DRIVE, 36TH FLOOR, CHICAGO, IL, 60606, US

(21) Appl. No.: 10/922,011

(22) Filed: Aug. 19, 2004

(51) Int. Cl. G06F 19/00

(52) U.S. Cl. 701/1; 701/102

(57) ABSTRACT

Program instructions and/or data used in vehicle computers can be downloaded into the vehicle from a personal computer, which obtains the information from a web server. Different types of programmed modifications can be readily downloaded into a vehicle simply by downloading the appropriate program. Once the program instructions and/or data are downloaded, they can be copied into a vehicle computer using available interfaces, such as the onboard diagnostic system connector (OBD-2) available on many vehicles.

### TECHNICAL FIELD OF THE INVENTION

The present invention relates to a system and method for remotely reprogramming or altering the factory programming of computers used in a vehicle.

### BACKGROUND OF THE INVENTION

Those of ordinary skill in the art know that motor vehicle manufacturers rely on one or more computers, e.g., microcontrollers, microprocessors and even digital signal processors, to provide safe and energy-efficient vehicles. Gasoline-fueled engines are controlled by a computer, which is commonly referred to as the engine control unit or “ECU.” Among other things, the ECU monitors the engine's rotational speed (RPM), the load on the engine as determined in part by throttle position and intake manifold pressure, coolant temperature, exhaust-stream oxygen content, ambient temperature and ambient atmospheric pressure, in order to adjust ignition spark timing, fuel mixture and transmission gear selection in order to maximize either fuel efficiency or engine output power while minimizing output emissions.

In addition to an engine control unit, many automobiles use a separate computer to control the vehicle's automatic transmission. Working in conjunction with the ECU, the transmission control unit or “TCU” determines when to upshift, downshift and lock-up the torque converter.

Other vehicles use a separate computer to control the vehicle's air bag deployment and/or occupant seat belt tensioners. The anti-lock brakes that improve a car's maneuverability in emergency braking situations are computer-controlled. More recently, vehicles have become available with navigation systems, entertainment systems and anti-theft systems. Onboard navigation systems typically have a database on board the vehicle by which one or maps can be displayed on a dashboard-mounted screen. DVD and VCR playback systems, MP3 players, cellular telephones and global positioning system-assisted navigation systems also require their own computer systems. Anti-theft systems, such as ignition key readers, voice recognition systems and electronic locks provide additional security.

While computer technology has provided improved motor vehicle entertainment and navigation and it has provided improved safety, engine performance and fuel efficiency, computer technology has not been utilized to its fullest extent. The computer technology that has provided so many improvements to the automobile could be used to an even greater extent if factory-installed programming in a vehicle could be easily modified after a vehicle is manufactured and sold. More importantly, the ability to modify a vehicle's characteristics by simply changing program instructions or data would be an improvement over the prior art. A system and method by which the programs and/or data in a vehicle's computer can be re-programmed would be an improvement over the prior art.

### SUMMARY OF TE INVENTION

Performance-modifying programs and/or performance-modifying data for a vehicle computer is located on an Internet web server. The programs and/or data is downloaded via the web to a client PC after accessing the web site. The client PC can then download the programs and/or data into the vehicle computer as a stand-alone programmer. In an alternate embodiment, the vehicle computer reprogramming is performed in real time or nearly-real time by the web server with the client PC acting as a proxy for the server. Software updates and performance modifications can be accomplished quickly.

### BRIEF DESCRIPTION OF THE DRAWINGS

FIG. 1 is a block diagram of a system and system components to distribute programs and/or data for vehicle processors via the Internet.

FIG. 2 is a flow chart depiction of a method of distributing programs and/or data for vehicles from a web server.

FIG. 3 is a flow chart depiction of a method of downloading programs and/or data for vehicles from a web server.

### DETAILED DESCRIPTION OF THE PREFERRED EMBODIMENTS

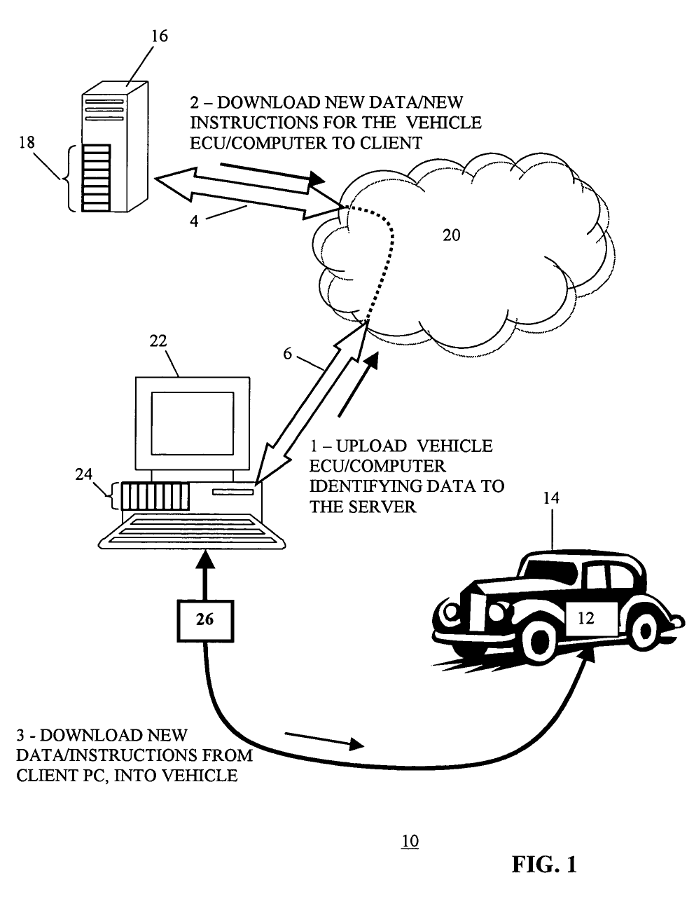

FIG. 1 depicts a system 10 for remotely programming the computer 12 in a motor vehicle 14 that is known as the engine control unit “ECU.” The programming is accomplished using information that is transported via the web 20.

In one embodiment, the vehicle's ECU 12 is reprogrammed by first downloading a file into a client PC 22 from a web server 16. Thereafter, the file that was downloaded from the server 16 into the client PC 22, is downloaded from the client PC 22 into the ECU 12 of the vehicle 14 through an interface port, such as the ECU on-board diagnostics connector through which various engine parameters and ECU software are made accessible by the vehicle manufacturer for diagnostic purposes.

In another embodiment, a virtual connection between the server 16 and the ECU 12 is established through the web 20 and through the client PC 22. In this alternate and equivalent embodiment, the ECU 12 is in effect reprogrammed by the server 16, with the client PC 22 acting as a “proxy” for the server 16, i.e., a local terminal into the ECU 12 for the server 16.

In the first embodiment set forth above, a file to be copied into the ECU 12 is first downloaded to the client PC from the server 16. The downloaded file resides in the client PC 22 until a connection is made to the ECU 12 from the client PC 16 and the file is downloaded into the ECU 12. The file can be kept in RAM or on magnetic or optical disk until such time as the ECU is properly coupled to the client PC. Unless the downloaded file is protected, copies of the file can be downloaded into multiple ECUs.

In the second embodiment, the client PC acts only as a conduit for data communications that take place between the ECU 12 and the server 16 via the web 20. Any sort of data communications protocol, passwords or “handshaking” that is required by the ECU 12 to reprogram the ECU is 12 performed by the client 22, but under the control of the server 16 via a communications session between the server 16 and the client PC 22 through the web 20 using TCP/IP or other data communications protocol. In such an embodiment, the client 22 acts as the so-called “proxy” for the server 16, by which is meant that the client 22 performs functions on the ECU for the server 16, which the server could do itself if it were physically connected to the ECU but is unable to do because it is remotely located from both the client 22 and the ECU 12. In either embodiment, performance-modifying data and/or instructions can be distributed to any client PC with web access such that different makes and models of vehicles can have the factory programming replaced from a centrally located computer.

The system 10 shown in FIG. 1 is relatively simple. It's comprised of one or more server computers 16 (one depicted for simplicity) and one or more client computers 22. The server 16 and the client computers 22 are both operatively coupled to the data network known as the Internet 20 via appropriate data links 4 and 6 respectively. As is well known, client computers 22 that access the web use an Internet browser program by which a web site domain name can be used to “log onto” or access a particular web site. The Internet, the web, web servers, data transmission and data links that couple computers together, are all well known to those of ordinary skill in the data communications arts. A discussion of them is therefore omitted for brevity and clarity.

The server computer 16 acts as (i.e., it “hosts”) a web site, the implementation details of web sites per se being well-known. In other words, the server 16, or other computers linked to it, provides the functionality of an Internet web site, having its own domain name and a corresponding IP address. The server 16 includes within it, one or more memory devices 18, including, but not limited to, random access memory or “RAM,” magnetic disk, optical disk, and/or magnetic tape, each of which can store computer data and/or program instructions. The memory devices 18 store data and/or instructions for one or more processors used in one or more vehicles. (The terms “computer” and “processor” are used interchangeably and should be construed to be equivalent.)

The server computer 16 stores within it, a “data base” of computer programs and/or computer data, each of which can be used by a vehicle's ECU to modify or alter the vehicle's engine performance from its original factory conditions. Engine-performance modifying data that can be downloaded into the ECU 12 and alter an engine's performance can include, but is not limited to, program limits on engine RPM, fuel metering data. Programming modifications made up of executable instructions for the ECU might include instructions that cause the ECU to ignore one or more sensors, the outputs of which might limit engine output power to reduce emissions.

Several different performance-modifying data parameters or program instructions can be stored for each ECU of a particular vehicle make, model and year with each program providing a slightly different engine performance. For purposes of claim construction, any sort of computer or computer network that provides digital information embodied as either computer program instructions or program data for the processors used in a vehicle, and by which such digital information is made available via downloads over the Internet, should be considered hereafter to be a “server means for distributing vehicle processor control information.”

As set forth above, web-enabled engine re-programming can be accomplished by downloading one or more files from the server 16 to the client 22 over the web 20. In such an embodiment, the client 22 can then download the one or more files into the ECU 12 by having the client 22 communicate with the ECU 12. Alternatively, web-enabled engine re-programming can be accomplished by downloading one or more files from the server 16 into the ECU 12 via the web 20 and through the client PC 22, whereby the client PC acts as a proxy for the server 16 and acts to establish near real-time communications between the server 16 and the ECU 12 via the web 20. By providing re-programming data and/or instructions via the web, acquiring the programs and installing them into a vehicle is simplified and the cost of updating software or modifying an engine's performance is reduced when compared to the cost of purchasing new EEPROMs and the associated labor required to correctly install them into the vehicle. From the perspective of an operator of the server 16, distribution of new or modified ECU software and/or data as well as software and/or data for other vehicle processors is greatly simplified. Media costs and shipping expenses required to deliver EEPROMs or other devices is eliminated, making it economical to distribute engine performance-modifying software for fees received from end users or distributors. Accordingly, in at least one embodiment, the server 16 is programmed to limit distribution of new instructions and/or data to users who have paid for the right to receive the service.

Re-programming a vehicle's ECU is accomplished by way of the client computer 22 accessing the server 16 by providing the server's URL to a browser program running on the client PC 22. A new program and/or data for a vehicle's ECU can thereafter be downloaded from the server 16 using well-known methods of transmitting files across the web 20. Once the client 22 has the new program and/or data, the client 22 can download the data into the ECU.

In some embodiments, the server 16 can have several different programs or data loads for a particular vehicle. In such embodiments, the server 16 permits the client 22 to request one or more particular performance-modifying files. Once a new program and/or data is obtained by the client computer 22, the client computer downloads the new program and/or data into the motor vehicle computer 12 via an appropriate interface 22 into the ECU. The foregoing contemplates one or more computers that are capable of accessing a web site and receiving from such a web site, either computer program instructions or data for a processor used in a vehicle as a client computer means for obtaining vehicle processor programming information. In addition, any one or more computers that are capable of acting as a proxy for another computer, with which communication can be had via a network such as the Internet should also be considered a client computer means for obtaining vehicle processor programming information.

As is well known, many vehicles are factory-equipped with a multi-pin connector that functions as a port into the ECU 12. This connector is known as the OBD-2 connector (on-board diagnostic connector, second version). It is well known to those of skill in the automotive service industry as a mechanism through which the ECU 12 and its stored programming and data can be accessed. In many vehicles, the ECU 12 requires certain commands to be sent to it through the OBD-2 connector before it will allow access to programming information. The commands sent to the ECU 12 are considered to be at least part of the communications “protocol” to be followed in order to communicate with the ECU 12. A physical connection to the ECU 12 over which the communication protocol occurs is the electrical connection (or wireless data link) between the client computer 22 and the ECU 12. The commands to the ECU 12 and responses from it can be generated by the client 22 or the server 16 in embodiments where the client 22 acts as a proxy for the server 16. Because there are many different vehicle manufacturers and many different vehicles, a complete listing or even a comprehensive description of every interface device 26 for every vehicle is not feasible. Therefore, for purposes of claim construction, any structure or device that allows access to the digital information stored in a vehicle processor should be considered to be an “interface means for allowing access to programming data and/or instructions” with the ECU or any other processor of a vehicle.

By using the system depicted in FIG. 1, data and/or instructions in a vehicle's ECU 12 can be modified simply by having the client computer 22 access the web site hosted by the server 16 and downloading new data and/or instructions from the server 16. As set forth above, data and/or instructions can be downloaded from the server 16 into the client 22 where they are stored for later downloading into the ECU 12. In another embodiment, data and/or instructions for an ECU 12 pass through the client 22 and into the ECU 12, in nearly real-time with the client 22 acting as a proxy for the server 12 with respect to the ECU 12. In either embodiment, the electrical signals that comprise the communications protocol required of the ECU 12 are provided to the ECU 12 from the client PC 22.

In either embodiment, the process of reprogramming or modifying the program of an ECU 12 includes three general steps. First, the web server 16 is accessed by the client computer 22, which then uploads vehicle and/or ECU-identifying data to the server 16. In a second step, after having received the ECU-identifying information, the server determines if it has an alternative programming “load” for the particular ECU 12 that was identified to it in the first step, after which it downloads the new data and/or program to the client computer 22. In a third step, the client 22 either takes control of the ECU 12 and writes the new data and/or instructions into the ECU 12 or acts as a conduit or proxy by which the server 16 downloads information into the ECU albeit over the web 20.

In at least one embodiment, accessing the server 16 is conditioned upon supplying it with a password, login or other data from the client computer 22 that identifies a person using the client computer 22 as someone who is authorized to access and obtain reprogramming data. Persons who are “authorized” to access the site provided by the server 16 can include individuals who have paid the site provider for access rights. The process by which site access is determined is commonly known as “logging onto” or “registering with” the web-hosting server computer 16. Controlling access to the web site provided by the server 16 is useful to generate revenue. User IDs and/or passwords can be sold and used to determine or limit the access rights. For example, different download rights can be provided to different user IDs. If an invalid user ID or password is provided, access to the site and access to new program information for vehicle computers can be denied.

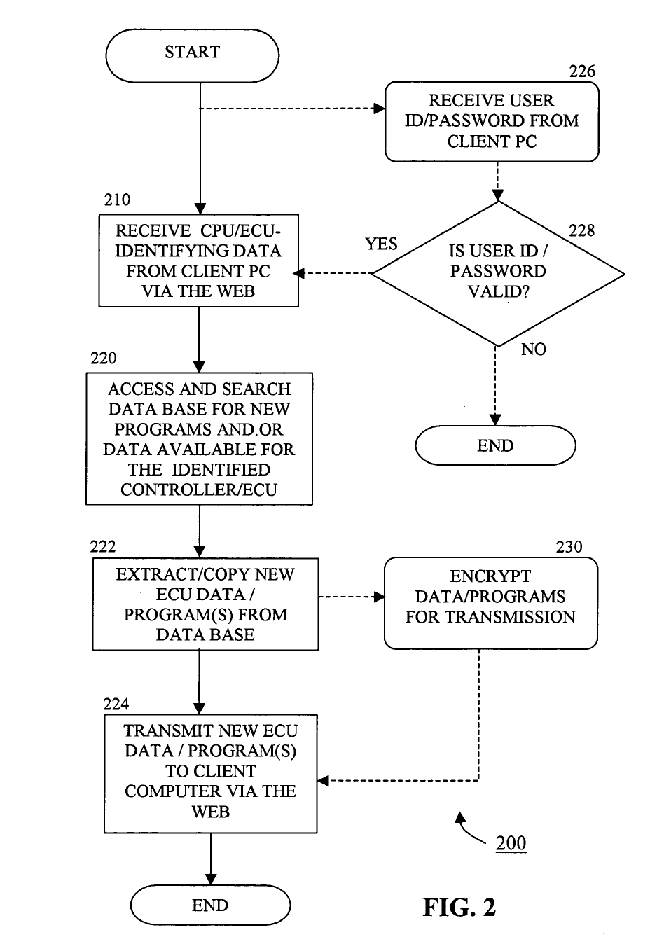

FIG. 2 depicts steps of a method for remotely programming a vehicle computer, such as an ECU 12, as “seen” by the server 16. The roles of the server 16 include limiting access to the web site it hosts but more importantly, providing remote programming of an ECU via the web 20 and a client computer 22.

With regard to FIG. 2, in one embodiment, access to the server 16 (and therefore data and/or programming instructions for an ECU) is conditioned upon the server 16 receiving a valid user ID or password from the client computer 22. In such an embodiment, revenue can be generated by limiting site access to those who have paid for site access. Different types of user IDs and/or passwords can be distributed upon payment of different amounts of money, each type being used by the server 16 to enable a person to obtain different numbers and types of access to data and/or programs stored within the server 16. By way of example, one type of user ID purchased for a first amount can allow unlimited numbers of downloads. A second type of user ID purchased for a second and lesser amount might allow only a single download.

In one embodiment, access to the server 16 is based on a pay-as-you-go system. Authorized distributors are given access to the database and are billed based on what they do using one-week billing cycles. The database creates reports showing the weekly distributor activity. The reports can also be directly linked to an internal accounting system. Invoices are generated from these reports and sent to our distributors. In an alternate embodiment, access to the server 16 can be on down load-by-download basis. A distributor or an end user can pay for program loads as desired.

In light of the foregoing, if server access is conditional, step 226 requires receipt of a valid user ID, password, or other indicator that the person operating the client computer 22 and attempting to access the server 16 via the web 20, is in fact authorized by the server operator to access the server 16. If the user ID, password or other indicator is invalid as determined in step 228, in at least one embodiment, access to the server 16 is prohibited and program execution effectively ceases.

As shown in FIG. 2, after access to the site hosted by the server 16 is obtained, the user needs to provide the server 16 with data or other information that identifies the vehicle make and model or the vehicle's ECU 12 for which new data and/or instructions are sought. Step 210 therefore depicts the server 16 receiving CPU/ECU identifying information from the client 22. It should be noted that the client computer 22 can also query the ECU 12 and identify the ECU 12 from data stored within it. Thereafter, the client 22 uploads the ECU 12 identity to the server 16. In either case, the server 16 needs to know what data and/or program to download.

Once the ECU 12 for which new data and/or program instructions are sought is identified, the server 16 determines if in fact it has a new load available and locates the data and/or programming files for the ECU 12, if they exist. Step 220 therefore depicts the server's search of one or more data bases of programs and/or data for ECUs to determine if the server 16 has one or more such “loads” available to send. In at least one other alternate embodiment, step 220 includes a check of the processor-identifying information that was provided by the client computer 22 to see if it's valid. For brevity, such a step has been omitted from FIG. 2.

In step 222, the server 16 copies data and/or instructions for the processor or ECU from the database. In step 224, the data and/or instructions are sent to the client computer 22 via the web in an appropriate file download. It should be noted that in at least one alternate and equivalent embodiment, data and/or programming instructions can be read from the database and transmitted to the client 22 without the creation of an intermediate copy of the database contents.

In another alternate embodiment, data and/or instructions to be downloaded are encrypted prior to transmission. Step 230 therefore shows the encryption of the data and/or programs after they're located in step 222 but prior to their transmission in step 224. Encryption is particularly useful in embodiments where the client 22 acts as a proxy for the server 16 because the encryption can prevent unauthorized copies of the download from being distributed without authorization of the copyright holder of the work of authorship being downloaded. In such an embodiment, it is preferable to download the decryption algorithm to the client 22 in a form and by a method that prevents the decryption algorithm from being copied and stored on a media from which it can be copied.

File transfers via the Internet are well-known and can be performed by a variety of protocols including, but not limited to TCP/IP. The precise details of the file transfer between the server 16 and the client computer 22 is omitted for brevity.

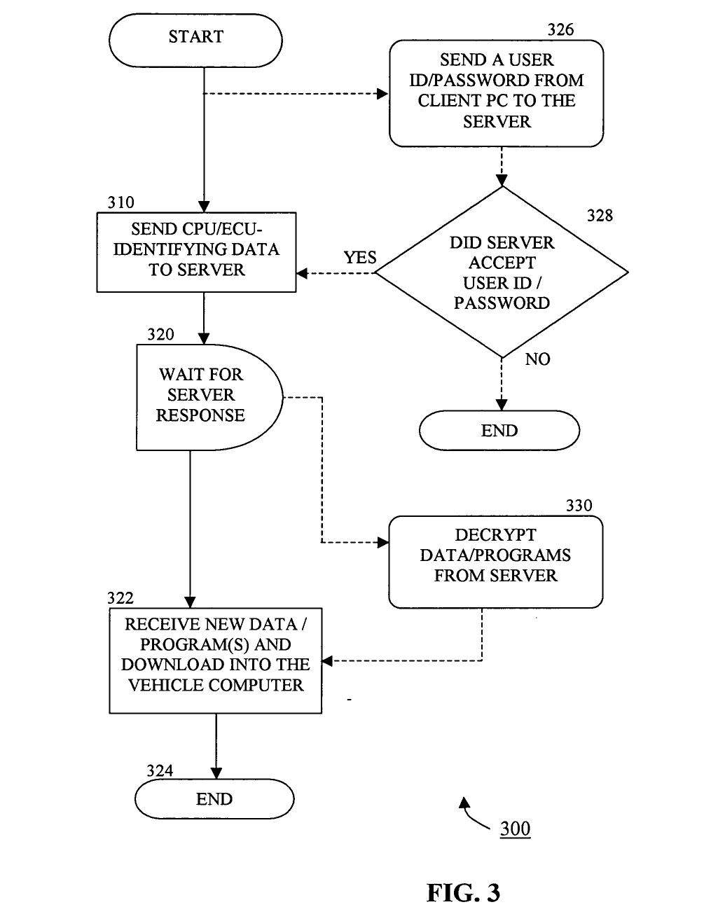

The process of reprogramming a vehicle computer such as an ECU as seen from the client computer 22 is depicted in FIG. 3. For embodiments of the system 10 that condition server 16 access on the receipt of a user ID or password, step 326 depicts the client 22 providing a user ID and/or password that is provided to an authorized user. If the server accepts the user ID/password per the test in step 328, program control proceeds to step 310 where the client computer 22 uploads “CPU/ECU identifying data” to the server 16.

Inasmuch as the server 16 requires a finite amount of time to search records, step 320 depicts the client computer 22 waiting for a response from the server 16.

In embodiments where the server 16 encrypts data and/or programs prior to download, step 330 depicts the client computer's decryption of the downloaded file(s). In step 322, the new data and/or programs obtained from the server 16 are downloaded into the vehicle computer through the interface 26 device shown in FIG. 1.

In embodiments where the client 22 acts as a proxy for the server 16, the client 22 conducts a web-based communication session with the server 16 while it conducts a different communication session with the ECU 12. In so doing, the server 16 communicates with the ECU 12 via the client 22 and via the web 20 such that near real-time data communications takes place between the server 16 and the ECU 12.

It should be noted that other embodiments contemplate downloading instructions to the vehicle processor by which newly downloaded information from the server 16 is masked by the ECU 12 in order to protect the economic investment of the developer of the after-market data and/or instructions. Additional routines are downloaded, which when executed by the ECU mask or encode the data downloaded from the server 16 into all ones or all zeroes under certain conditions, which will preclude someone from pirating newly downloaded information.

Those of ordinary skill in the art will recognize that while the preferred embodiments of the invention contemplate reprogramming the ECU of a motor vehicle, the system and system elements shown in FIG. 1 and the methods depicted in FIGS. 2 and 3 can also be used to reprogram other computers used in a motor vehicle. As is well known, motor vehicles are being equipped with processors that control the automatic transmission, a DVD player, MP3 players, CD changers, cellular telephones, GPS and on-board navigation systems. By using a connector or other interface through which the storage media in which programs and data for these processors can be altered, the system 10 depicted in FIG. 1 and the methods shown in FIGS. 2 and 3 can be used to modify or reprogram the processors to modify vehicle performance or update the processors' functionality over a vehicle's useful life. For example, the operation of an automatic transmission control unit, an entertainment system, such as a DVD player, MP3 player, CD changer, a cellular telephone, the anti-lock brakes, occupant restraint systems, as well as the broadcast receivers might all be enhanced, deleted or otherwise modified by using the foregoing methods and apparatus.' Latent software programming errors known as “bugs” could also be fixed after a vehicle is sold. Map databases used by on-board navigation systems can also be updated and/or reprogrammed after the vehicle's manufacture to provide the vehicle with new or better performance and/or additional maps, operating features or simply to correct software bugs. Therefore, for purposes of claim construction, the claims should not be limited to reprogramming an ECU but should be broadly construed to include other processors on board a vehicle that are amenable to reprogramming. The terms “processor” and “computer” and “controller” should therefore not be limited to an engine control unit but should be read to include other computer-controlled systems in a vehicle.

Although the forgoing text sets forth a detailed description of different embodiments of the invention, it should be understood that the legal scope of the invention is defined by the words of the claims set forth hereinafter. Thus, the detailed description is to be construed as exemplary only and does not describe every possible embodiment since describing every possible embodiment would be impractical.

Numerous alternative embodiments can be implemented, using either current technology or technology developed hereafter which will fall within the scope of the claims defining the invention. It should also be understood that, unless a term is expressly defined in this patent, there is no intent to limit the meaning of a claim term, either expressly or by implication, beyond its plain and ordinary meaning as such terms would be understood by those of ordinary skill in the art. Finally, it is not intended that the scope of any claim element should be interpreted based on application of 35 U.S.C. § 112, ¶6 except for those claims, if any at issuance, that use the terms “means for.”

What is claimed is:

1. A system for programming a computer in a vehicle via the Internet, said system being comprised of:
a server computer, operatively coupled to the Internet, said server computer comprised of:
a first memory device, storing computer program instructions, which when executed, cause the server computer to send to at least one client computer via the Internet, at least one of: data and instructions, which are to be loaded into the computer in a vehicle;
at least one client computer, operatively coupled to the server computer via the Internet, said client computer comprised of:
a second memory device, storing computer program instructions, which when executed, cause the client computer to receive from said server computer via the Internet, at least one of: data and instructions, for a computer in a vehicle, said at least one client computer including an interface device that couples the client computer to said computer in a vehicle and which enables at least one of the, data and instructions received from the server computer to be copied into said computer in the vehicle; and
an interface device for coupling the at least one client computer to an interface of said computer in a vehicle.

2. The system of claim 1 wherein said computer in a vehicle is comprised of an engine control unit.

3. The system of claim 1, wherein said at least one client computer includes memory containing program instructions, which when executed, cause the client computer to function as a proxy for the server computer.

4. The system of claim 1, wherein the at least one client computer includes memory that stores computer program instructions, which when executed cause the client computer to receive a file downloaded from the server computer and store it for a later download into a processor for a vehicle.

5. The system of claim 1 wherein said interface for coupling the at least one client computer to an interface of said computer is a connector for coupling the at least one client computer to the vehicle's on-board diagnostic (OBD2) connector.

6. The system of claim 1 wherein said at least one of data and instructions, to be loaded into the computer in a vehicle, is further comprised of at least one of: data and instructions, to change a vehicle's engine's operating characteristics.

7. The system of claim 1 wherein said at least one of data and instructions, to be loaded into the computer in a vehicle, is further comprised of:
at least one of: data and instructions to enable a vehicle's engine to use a different grade of fuel.

8. The system of claim 1 wherein said at least one of data and instructions, to be loaded into the computer in a vehicle, is further comprised of:
at least one of: data and instructions to inhibit a vehicle's engine from starting.

9. The system of claim 1 wherein said at least one of data and instructions, to be loaded into the computer in a vehicle, is further comprised of:
at least one of: the original data and instructions originally installed into the engine controller by its manufacturer.

10. The system of claim 1 wherein said computer in a vehicle is a computer for at least one of:
a computer for a vehicle's entertainment system;
a computer for a vehicle's occupant restraint system;
a computer for a vehicle's navigational system;
a computer for a vehicle's braking system; and
a computer for a vehicle's theft deterrent system.

11. The system of claim 1 wherein:
said first memory device stores computer program instructions, which when executed, cause the server computer to receive from said at least one client computer via the Internet, at least one of: data and instructions, from a computer in a vehicle and to store said instructions from a vehicle; and
said second memory device stores computer program instructions, which when executed, cause the client computer to send to said server computer via the Internet, at least one of: data and instructions, from a computer in a vehicle.

12. A server computer, for remotely programming a computer in a motor vehicle comprised of:
a first processor, operatively coupled to the Internet;
at least one memory device, operatively coupled to said first processor, said at least one memory device storing:
at least one of: data and instructions, for an engine controller of at least one make and model of a motor vehicle;
computer program instructions, which when executed, enable the first processor to send to a second processor via the Internet, at least one of: data and instructions for a computer of a vehicle, said data and instructions to be downloaded by said second processor into a computer in a motor vehicle.

13. The system of claim 12, wherein said first memory device stores computer program instructions, which when executed, cause the first processor to function as an Internet web-site server.

14. The server of claim 13, wherein said first memory device stores computer program instructions, which when executed, cause the first processor to require said second processor to provide identifying data to said first processor, prior to said first processor sending data or instructions to said second processor, said identifying data identifying a person who is authorized to receive data and instructions from said first processor.

15. The server of claim 13 wherein said first memory device stores computer program instructions, which when executed, enable the first processor to receive at least one of: data and instructions, from an engine controller of a vehicle.

16. The server of claim 13 wherein said at least one memory device is a memory device that stores at least one of:
data for a processor of the vehicle's entertainment system;
data for a processor of the vehicle's occupant restraint system;
data for a processor of the vehicle's navigational system;
data for a processor of the vehicle's braking system; and
data for a processor of the vehicle's theft deterrent system.

17. The server of claim 13, wherein said at least one memory device stores computer program instructions, which when executed, enable the server to send the at least one of: data and instructions for a computer of a vehicle, after the server's receipt of a valid identifier.

18. A client computer for re-programming a computer in a motor vehicle, said client computer comprised of:
a processor, capable of being coupled to the Internet and to a computer in a motor vehicle;
a vehicle interface device, operatively coupled to the processor, enabling the processor to be operatively coupled a computer in a motor vehicle;
a memory device operatively coupled to said processor, said memory device storing computer program instructions, which when executed, cause the processor to receive via the Internet, at least one of: data and instructions, for the computer in a motor vehicle.

19. The client computer of claim 18 wherein said memory device stores computer program instructions, which when executed cause the client computer to perform as a proxy for a server computer that is accessed by the server computer via a web site.

20. The client computer of claim 18 wherein the vehicle interface device is comprised of a connector that is compatible with a vehicle's on-board diagnostics connector.

21. The client computer of claim 18 wherein the processor is a processor that is capable of being coupled to a web site server via the Internet, from which engine control data and/or instructions can be downloaded.

22. The client computer of claim 18 wherein the processor is a processor that is capable of being coupled to a vehicle's engine control unit and the web site server simultaneously.

23. The client computer of claim 18 where the memory device stores computer program instructions, which when executed cause the processor to read at least one of data and instructions from the vehicle's engine control unit.

24. A method of remotely re-programming an engine control unit of a motor vehicle, said method comprising the steps of:
receiving at a server computer from a client computer via the Internet, data that identifies an engine control unit of a motor vehicle;
said server computer:
accessing a data base wherein data for a plurality of engine control units is stored;
selecting from the data base, data for the engine control unit identified by said data; and
sending said data to said client computer via the Internet.

25. The method of claim 24 further comprising the step of:
receiving from a client computer, client-identifying information that identifies a person who is authorized to receive data for an engine control unit of a vehicle from said server; and
inhibiting the transmission of engine control unit data to a server if the client-identifying information is invalid.

26. The method of claim 24 including the step of encrypting data to be located in the engine control unit for a vehicle, prior to transmitting the data to the client computer.

27. The method of claim 25 further including the step of: determining if said client identifying information identifies a person who has paid for access to the server.

28. A method of re-programming an engine control unit of a motor vehicle via the Internet, said method comprising the steps of:
sending a first data via the Internet from a first computer to a server computer, said first data identifying an engine control unit of a motor vehicle;
receiving from said remotely located server via the Internet, a second data to be loaded into the engine control unit for said motor vehicle;
downloading the second data received from the server computer, into the engine control unit for said motor vehicle.

29. The method of claim 27 further comprising the step of:
sending to said server computer, information that identifies a person who is authorized to receive data for an engine control unit of a vehicle from said server.

30. The method of claim 27 including the step of decrypting data received from the server, prior to downloading said data into the engine control unit of a vehicle.

31. A system for remotely programming a computer in a vehicle via the Internet comprised of:
a server means for distributing vehicle processor control information;
a client computer means for obtaining processor control information, said client computer means being operatively coupled to said server means via the Internet; and
an interface means, operatively coupled to the client computer means, said interface means for allowing access to programming data and/or instructions.

32. A device for remotely programming a computer in a vehicle via the Internet comprised of:
a server means for distributing vehicle processor control information; and
a data link, operatively coupling the server means to the Internet.

33. A device for remotely programming a computer in a vehicle via the Internet comprised of:
a client computer means for obtaining processor control information, said client computer means being operatively coupled to said server means via the Internet; and
an interface means, operatively coupled to the client computer means, said interface means for allowing access to programming data and/or instructions.
